(19) United States
(12) Patent Application Publication
(10) Pub. No.: US 2011/0173564 A1
(43) Pub. Date: Jul. 14, 2011

(54) EXTENDING VIEW FUNCTIONALITY OF APPLICATION

(75) Inventors: Radu C. Margarint, Kenmore, WA (US); Andrew D. Cox, Redmond, WA (US); Gary W. Flake, Bellevue, WA (US); Karim T. Farouki, Seattle, WA (US); Alan K. Wu, Bellevue, WA (US)

(73) Assignee: MICROSOFT CORPORATION, Redmond, WA (US)

(21) Appl. No.: 12/687,123

(22) Filed: Jan. 13, 2010

(51) Int. Cl. G06F 3/048

(52) U.S. Cl. 715/786; 715/800

(57) ABSTRACT

The viewing functionality of an application may be extended by use of an adapter. An application is instantiated, and the application may provide a view box that contains a scrolling feature as part of its interface. The adapter uses the application “behind the scenes” to collect information in a way that is not visible to the user. Mouse gestures may be defined to perform various viewing functions such as zooming. The adapter intercepts these gestures in the window that the user uses to interact with the application, and interprets the gestures as specific view commands (such as zoom). Based on the commands (or, possibly, in anticipation of commands that have not yet been issued), the adapter uses the application to collect content. The application then scales the content appropriately, puts the scaled content in a document, and overlays the document on top of the view box.

### BACKGROUND

As technology progresses, users of computers and other devices expect an increasing amount of flexibility in how they view documents. In early computer displays, information was presented as lines of text on a screen. When the screen filled with text, that text was scrolled up the screen to make way for new text. Eventually the top line would be scrolled off the top of the screen and would become irretrievable. Later developments allowed user-controlled vertical scrolling, which allowed a user to scroll text up and down to bring it in and out of view.

Presently, many user interfaces allow additional flexibility, such as horizontal scrolling and zooming. However, many existing applications do not support these additional forms of viewing flexibility. Moreover, some new applications (e.g., some Java-based web applications) provide viewing areas that have only simple vertical scrolling functionality. Users have become accustomed to increased viewing capabilities such as zooming and vertical and horizontal scrolling, and may want to use these capabilities even with applications that do not provide these capabilities natively.

### SUMMARY

Various viewing capabilities, such as zooming, may be provided to an application through the use of an adapter. An application, such as a web application that is accessible through a browser, may display a view box that has scrolling capability. The view box may be used to show some underlying content (e.g., text, images, etc.), to a user. In order to add additional capabilities such as zooming to the user experience, a view adapter controls the application to collect pixels that are displayed through the view box. Once the adapter has these pixels, it can scale the pixels to any size, and can place these pixels in a document, which can be shown to the user as an overlay over the view box.

In order to provide the user with the impression that the additional capabilities, such as zooming, have been added to the user experience, the adapter intercepts the user's gestures (e.g., left and right movement of a mouse to indicate zooming), and uses these gestures to decide what content to show to the user. The adapter then uses the second instance of the application to collect the appropriate pixels from that content (or collects the pixels proactively in anticipation of user commands), and places the pixels in the document. The adapter substitutes the document that it has created in place of the underlying content that the application would otherwise display. So, for example, if the application would normally show the user a text document, the adapter overlays an image of the document that the adapter created over the original view box, so that the user sees that document instead of the original text document. This document may contain enlarged or reduced views of various regions of the original content.

Since the adapter collects pixels by “driving” the application as if the adapter were a real user, the adapter attempts to learn the location of the scroll bar in the application so that it can issue appropriate scrolling commands to collect pixels. In one example, the adapter learns the location of the scroll bar through metadata exposed by the application. In another example, the application learns the location of the scroll bar by observation—e.g., by watching the user's interaction with the application to see which actions cause the view box to scroll.

Additionally, the adapter can use the application to collect and store pixels in a way that increases the user's perception of speed and reduces the use of memory. For example, if the user appears to be panning in a certain direction in the document, the adapter can proactively collect the appropriate pixels from further along in that direction in the underlying content, thereby anticipating commands that the user has not yet issued. By having the appropriate pixels in advance, waiting time for the user is reduced, thereby increasing the user's perception of the application's response time. Additionally, once pixels have been placed in a document, the application may flush stored pixels to save space if it appears that the pixels represent regions of the document that are not likely to be requested by the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example application interface in which scrolling is available.

FIG. 2 is a block diagram of an example scenario in which support is provided for extending view functionality.

FIG. 3 is a block diagram of an example scenario in which original content is replaced with a substitute document.

FIG. 4 is a flow diagram of an example process in which certain viewing functionality may be provided to an application.

FIG. 5 is a flow diagram of an example process of observational detection.

FIG. 6 is a block diagram of example components that may be used in connection with implementations of the subject matter described herein.

### DETAILED DESCRIPTION

Users often like to have flexibility in how they view documents. As technology progresses, user interfaces accommodate increasingly more flexibility. In the early days of computers, text was presented to the user on a screen in a sequence of lines. When the screen filled, older lines ran off the top of the page and were irretrievable. In subsequent innovations, vertical scrolling was introduced to allow a user to move up and down in a document. Horizontal scrolling was also introduced as an alternative to word wrapping, thereby providing a way to show a line that is too wide to fit on one screen.

Typically, an area that is scrollable provides an area in which the user can specify whether the user wants to move up or down in the document (or left or right, in the case of horizontal scrolling). That area typically includes a scrollbar or “thumb” that the user can move up or down (or left or right) to indicate where he or she wants to move.

In addition to scrolling, users often like to be able to zoom in and out when viewing content. However, some applications provided scrolling capability but not zoom capability. The subject matter herein may be used to implement zoom functionality in an application that exposes scrolling functionality. In order to augment the viewing functionality of an existing application, a view adapter intercepts a user's gestures and other commands in order to determine what the user is trying to do. For example, the user might move a mouse right or left a view box, thereby indicating that the user wants to zoom in or out. Since the zoom functionality might not be implemented in the application itself, the adapter intercepts these gestures, obtains the appropriately-scaled content, and responds to the commands by displaying the scaled content over the view box of the application.

In order to obtain the appropriately scaled content, and to provide that content to the application, the adapter may perform actions as follows. For any given application that provides a view of an underlying document, the adapter may “drive” the application by interacting with the application's scroll capability. The adapter's interactions with the application may not be directly visible to the user, but the application can use these interactions to obtain content to show to the user. For example, the adapter can use the application's scroll capabilities to scroll up and down (or, possibly, left and right) in a document. The reason the view adapter navigates the document in this manner is to collect various portions of the document. For example, suppose that only one-tenth of a document can fit in a view box at one time. If a user indicates (through an appropriate zoom gesture) that he wants to see a de-magnified view of the document that comprises five view-boxes-worth of the document, the adapter can use its control of the application to scroll through the document and collect the five view-boxes-worth of that document. The adapter can then de-magnify the information that it has collected, so that it fits in one view box. In order to make the de-magnified version visible to the user, the adapter can put the de-magnified version in a virtual document that the adapter manages. Thus, the adapter puts the de-magnified view of the underlying document into the virtual document, and then exposes that virtual document to the user. For example, the adapter may overlay a view of the virtual document over the view box of the application so that the user sees the virtual document in the view box.

The adapter may use certain techniques to collect and store information about the document. For example, the adapter may provide many different zoom levels at which to view the document, but might not want to store the entire document at all zoom levels. Therefore, the adapter may collect portions of the document in response to a user's request for specific zoom levels, or may attempt to anticipate what areas of the document the user will view next, in advance of the user's having actually issued commands to view that area of the document. For example, if the user is viewing a document at a particular zoom level and appears to be scrolling or panning upward, the adapter may anticipate that the user will continue to scroll upward and will collect information higher up in the document before the user has actually requested it. Additionally, the adapter can conserve spaced by discarding portions of the document that the user has already viewed and has moved out of the viewing area.

In order to determine how to “drive” the application, the adapter may attempt to learn where the application's controls are. One way to learn where the application's controls are is to examine metadata exposed by the application. For example, the application may provide metadata that indicates where a scrollable viewing area and its scrollbar are located. Or, as another example, the adapter may infer the location of a scrollable viewing area and a scrollbar by observing user behavior and the actions taken by the application in response to that behavior. For example, the typical behavior that indicates the location of a scrollbar is: first the user clicks on the scroll thumb; then nothing happens; then the user starts to move the thumb up or down; and then the content in the viewing area moves up or down in the direction of the thumb. By observing this pattern, the adapter can detect the presence of a scrollable viewing area, and the location of the scrollbar. In another example, if the user clicks the mouse and then scrolling is observed, this pattern tends to indicate that the user has clicked the scroll bar somewhere other than the thumb. (The foregoing describes some techniques for detecting a vertical scroll bar, but analogous techniques could be used to detect a horizontal scroll bar.)

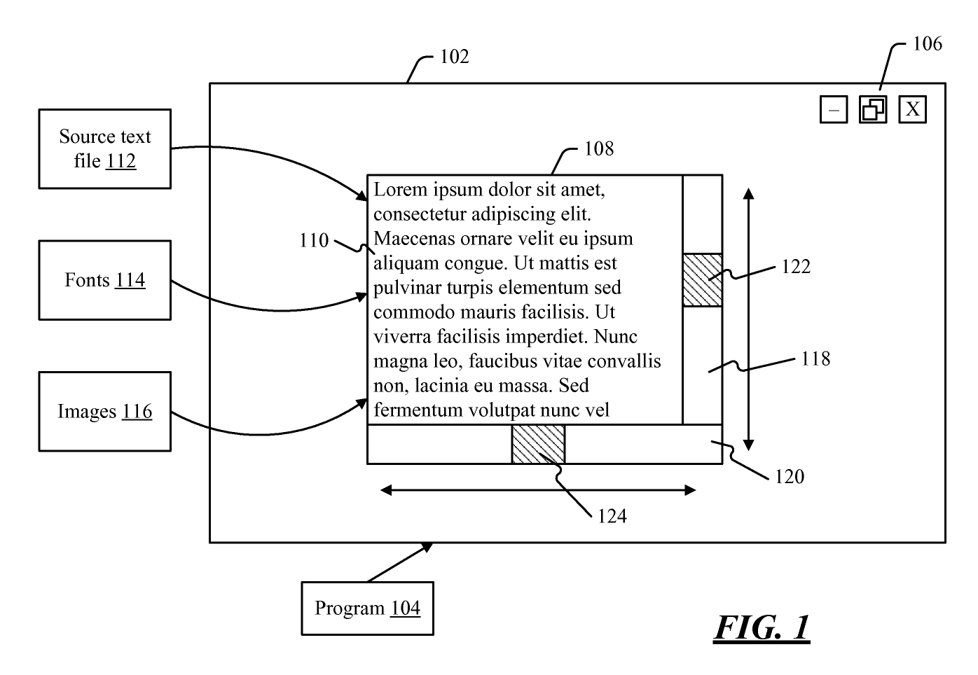

Turning now to the drawings, FIG. 1 shows an example application interface in which scrolling is available. Window 102 provides the user interface of program 104. For example, the program 104 whose interface is provided through window 102 may be a browser that processes information such as Hypertext Markup Language (HTML) and Java code to display some sort of content. Window 102 may have the normal controls that windows have, such as controls 106, which allow a user to hide, resize, and close window 102.

Within window 102, various types of content may be displayed by program 104. One example of such content is a view box 108, which allows some underlying content 110 to be displayed. In this example, the content 110 to be displayed is the familiar “Lorem ipsum” text content, although any type of content (e.g., text, images, etc.) could be displayed through view box 108. For example, when a browser is used to access some type of content, the content that is accessed may be a server-side application that provides the HTML or Java code that causes browser to display view box 108, and that also causes content 110 to be displayed through view box 108. Content 110 might be composed of one or more components, such as a source text file 112, fonts 114, and images 116. For example, the content 110 shown in view box 108 might be a newspaper article that contains text and images. The content is shown through pixels displayed through view box 108. The particular pixels that are shown contain text and graphics. The pixels that represent the graphics are derived from images 116. The pixels that represent the text are derived from source text file 112 and fonts 114—i.e., source text file 112 indicates which characters are to be drawn, and fonts 114 indicates how those characters will appear.

View box 108 provides controls through which the user may scroll through content 110 vertically and/or horizontally. For example, along the right and bottom edges of view box 108 are two rectangles 118 and 120 which are used to direct scrolling of content 110 in view box 108. Rectangles 118 and 120 contain scroll bars, or thumbs, 122 and 124, which allow the user to scroll up and down (thumb 122) and/or right and left (thumb 124). This scrolling functionality may be provided by the server-side application that provides view box 108. (In some examples, view box 108 might provide only vertical scrolling, or only horizontal scrolling. Techniques described herein may be used to extend viewing functionality to provide scrolling in a dimension that view box 108 does not provide natively.)

One viewing function that a user might want to perform is zooming or scaling. While scrolling capability allows the user to move content 110 up or down within view box 108, scrolling does not allow a user to make the content bigger (to see a smaller amount of content at greater detail), or to make the content smaller (to see a larger amount of content with less detail). There are various ways that the user could indicates functions such as “zoom in” or “zoom out” using a mouse. For example, a user might drag the mouse pointer right to indicate zooming in, or left to indicate zooming out. While such gestures could be made by a user, view box 108 might not provide native support for these gestures. Techniques provided herein could be used to provide such support, so that a user could zoom in and out on content (or perform any other appropriate viewing manipulation) even if such support is not provided natively by the application through which the content is being viewed.

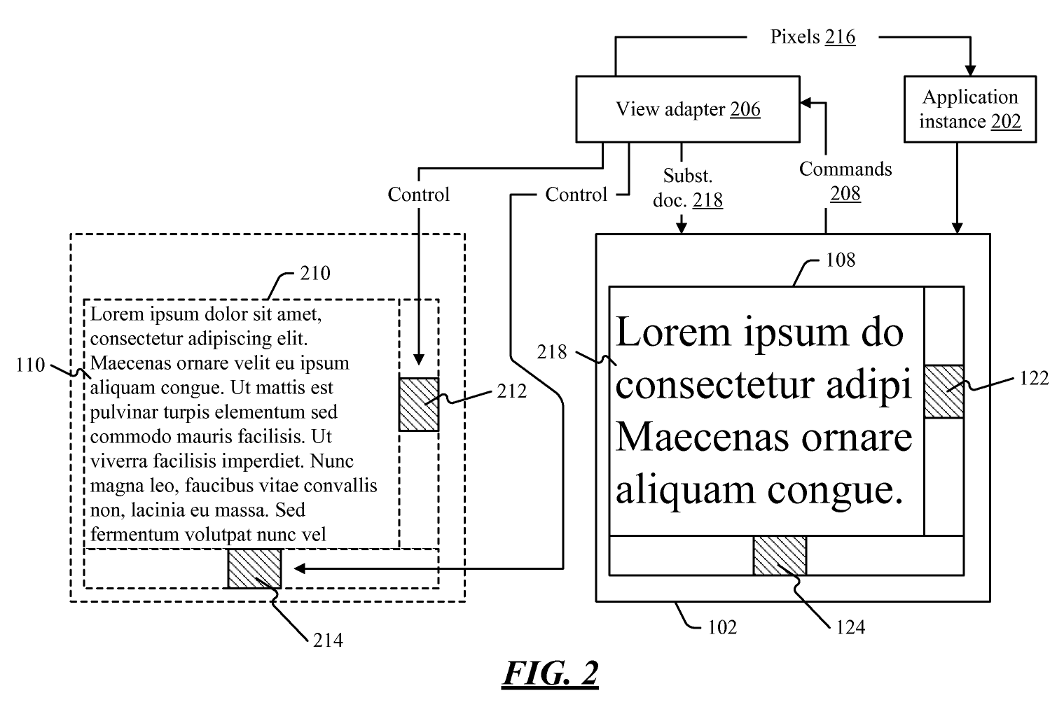

FIG. 2 shows an example way in which to provide support for extending view functionality. A server-side application provides a view box 108, which provides access to some underlying content (e.g., text, fonts, images, etc.), and a program (e.g., a browser) is opened in a window 102 that provides a view of this view box to a user. Additionally, view box 108 may provide thumbs 122 and 124 that allow vertical and/or horizontal scrolling (or, as noted above, view box 108 might provide scrolling only in one dimension.) These components are like those shown in FIG. 1. Application instance 202 is an instance of the application with which the user interacts. For example, the system may open a browser window to allow a user to interact with application instance 202. However, view adapter 206 may also interact with application instance 202 in a manner that is not visible to the user, as indicated by the dotted-line drawing of application instance 202's interface.

In particular, while the user interacts with application instance 202 through window 102, view adapter 206 intercepts commands 208 issued by the user. For example, if the user makes gestures such as the left-and-right gestures described above (indicating zoom-in and zoom-out functions), these gestures may be interpreted as commands 208, and view adapter 206 may intercept these commands 208. One way that view adapter 206 may intercept these commands is to observe keyboard and mouse interactions in window 102 whenever window 102 has focus. (“Having focus” is generally understood to mean that the window is active—i.e., that keyboard and mouse input is understood, at that point in time, as being directed to the window that has focus, as opposed to some other window.)

Regardless of the manner in which view adapter 206 intercepts the commands, once view adapter 206 has the commands 208 it may interpret the commands to determine what the user is trying to view. For example, a leftward motion may be interpreted as the user wanting to zoom out, thereby seeing less content, but a larger image of that content. View adapter 206 may then attempt to obtain the content that the user wants to see. View adapter 206 obtains this content by manipulating view box 210 in the application. View box 210 may provide thumbs 212 and 214 which allow the view of content within view box 210 to be controlled. The content to be displayed in view box 210 is the same content 110 that is displayed in view box 108 of FIG. 1. View adapter 206 controls the view of content 110 by controlling thumbs 212 and 214. It is noted that view adapter 206's manipulation of the view inside view box 210 may take place “behind the scenes”, in the sense that this manipulation is not actually displayed directly to the user. For example, the motion of arrows and the scrolling of content in view box 210 may not appear in any desktop window of the application. Rather, view adapter 206 simply works the input buffer of the application in such a way that the application believes it is receiving the same kind of commands that a user might have provided through a keyboard or mouse.

By working the controls of the application, view adapter 206 is able to view different portions of the underlying content 110. View adapter collects the pixels 216 that represent content 110. For example, if content 110 contains text, then pixels 216 are the pixels that represent characters of that text drawn in some font. If content 110 contains images, then pixels 216 are the pixels that represent those images.

When view adapter 206 has collected pixels 216, view adapter 206 uses the pixels to create a substitute document 218. Substitute document 218 is a “substitute” in the sense that it stands in for the original content 110 that a user is trying to view with application instance 202. It will be recalled that a user instantiated application instance 202 in order to view the underlying content 110. As described above, view adapter 206 interacts with application instance 202 in order to collect the pixels that represent content 110. View adapter 206 then arranges these pixels in ways that follow the user's commands. For example, if the user has indicated that he would like to zoom in on some portion of text (where the zoom feature is not natively supported by view box 108), then view adapter 206 creates an enlarged view of that text. In order to create this enlarged view, view adapter 206 uses application instance 202 to collect pixels that represent the portion of text on which the user would like to zoom, and then enlarges the view to an appropriate scale. This enlarged view is then placed in a document. View adapter 206 can then overlay an image of the document on top of the view box that otherwise would be visible to the user (i.e., on top of view box 108). Normally, application instance 202 would present content 110 through view box 108. However, since view adapter 206 overlays view box 108 with an image of substitute document 218, the user sees substitute document 218 in the place where the user is expecting to see content 110, thereby creating the illusion that the user has zoomed on content 110 as if the mechanisms to do so existed in view box 108. As can be seen, the text of content 110 appears larger in view box 108 (or, more precisely, in the overlay on top of view box 108) than in view box 210, indicating that substitute document 218 represents a zoomed view of that text, which is shown to the user.

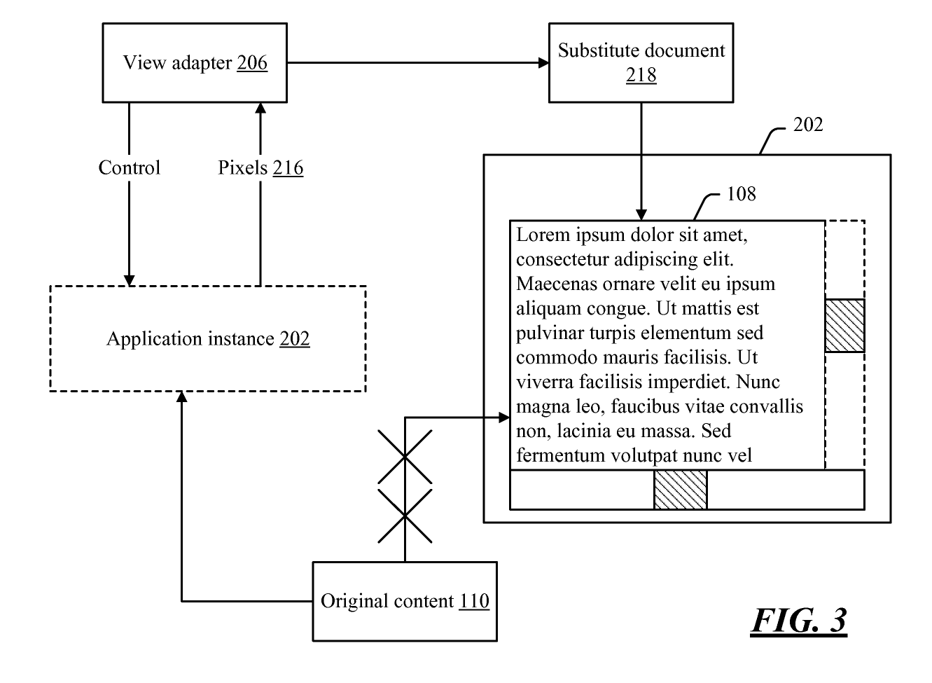

FIG. 3 shows how original content 110 is replaced with a substitute document 218. As discussed above, application instance 202 is normally instantiated to view content 110, which the application displays to a user through view box 108. However, when view adapter 206 is used, view adapter overlays an image of substitute document 218 on top of view box 108, thereby causing substitute document to be seen instead of content 110 (as indicated by the “XX” marks over the line between content 110 and view box 108). The content of substitute document 218 is controlled by view adapter 206. View adapter 206 fills substitute document 218 with pixels 216 that view adapter 206 has collected by controlling application instance 202 so as to collect those pixels from content 110. Thus, when a user sees content in view box 108, the user is seeing content that view adapter 206 has placed in substitute document 218, rather than the original content 110. In this way, view adapter 206 can enlarge, reduce, or otherwise transform the appearance of content 110 to show to a user in accordance with the user's commands—as long as view adapter 206 can collect this content in some manner. View adapter 206 collects the content, as described above, by “driving” the application in such a manner as to collect the pixels that it wants to place in substitute document 218.

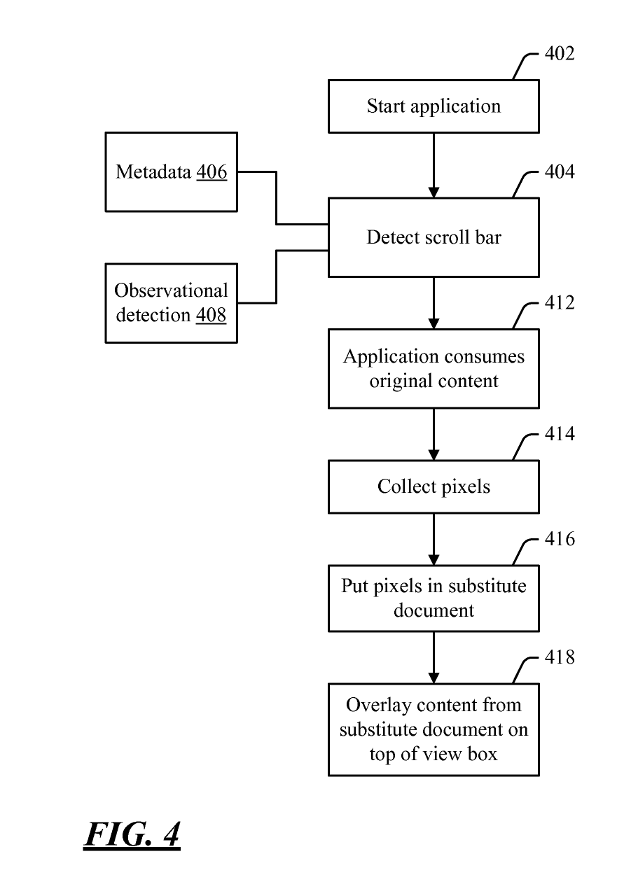

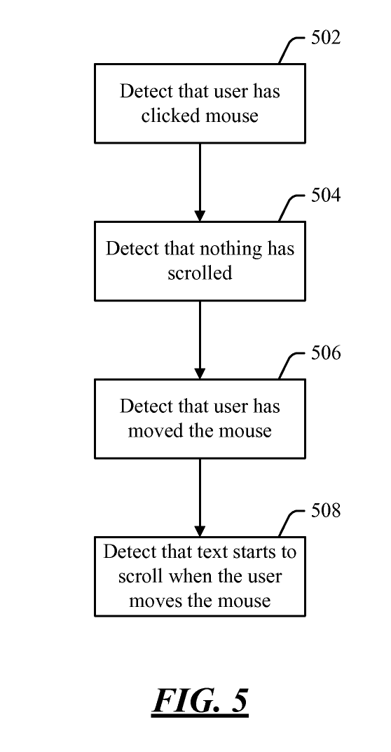

FIG. 4 shows, in the form of a flow chart, an example process in which certain viewing functionality (e.g., zooming) may be provided to an application. Before turning to a description of FIG. 4, it is noted that the flow diagrams contained herein (both in FIG. 4 and in FIG. 5) are described, by way of example, with reference to components shown in FIGS. 1-3, although these processes may be carried out in any system and are not limited to the scenarios shown in FIGS. 1-3. Additionally, each of the flow diagrams in FIGS. 4 and 5 shows an example in which stages of a process are carried out in a particular order, as indicated by the lines connecting the blocks, but the various stages shown in these diagrams can be performed in any order, or in any combination or sub-combination.

At 402, an application is started. For example, a user may invoke the browser program described above, and may use the browser to access an application that provides a view box in the browser window. At 404, the scroll bar in the view box is detected. For example, the view box may provide only vertical scrolling, in which case the vertical scroll bar is detected. Or, as noted above, a view box might provide both vertical and horizontal scroll bars, and both of these may be detected.

Detection of the scroll bar(s) can be performed in various ways. In one example, the application that provides the view box may also provide metadata 406 indicating the location of the view box and its scroll bar(s). In another example, observational detection 408 may be performed on the user interface in which the view box appears in order to detect the view box and/or its scroll bars. One way that this observational detection can be performed is as follows, and is shown in FIG. 5. First, it is detected (at 502) that the user has clicked a mouse button (or a button on some other type of pointing device, such as a touchpad). Then, it is detected (at 504) that, following the click of the mouse button, nothing has happened on the screen as a result of that click. Next, it is detected (at 506) that the user has started to move the mouse. Then, it is detected (at 508) that scrolling has occurred in response to the movement of the mouse—i.e., that something on the screen starts to scroll when the user moves the mouse. This sequence of actions tends to indicate that the user has used the mouse to operate the thumb of the scroll bar, since the observed actions are consistent with the user having operated the thumb. Using these observations, the location of the view box and the thumb are inferred.

Returning now to FIG. 4, at 412, the application consumes the original content that the user was using the application to view. For example, if the user is intending to use the application to view content 110 (shown in FIG. 1), then the application consumes content 110. The application may consume content 110 under the direction of view adapter 206 (shown in FIG. 2). While the view adapter is directing the view of content 110, the view adapter collects pixels from the document (at 414). At 416, the view adapter puts the pixels in a substitute document. At 418, content from the substitute document is overlaid on top of the application's view box, so as to make it appear that the application is showing the user content from the substitute document. For example, the view adapter may create an overlay on top of the location of the view box in the application, and may display content from the substitute document in that overlay.

It is noted that, when the view adapter uses the application to collect pixels, it may do so in various ways, and in response to various cues. For example, the view adapter may collect pixels from the underlying content in response to specific actions by the user. That is, if the user requests to zoom out, the view adapter may use the application to manipulate the underlying content and to collect several view boxes-worth of pixels, so that a zoomed-out view of several boxes worth of content can be shown to the user. However, in another example, the view adapter attempts to anticipate what the user will ask for. For example, if the user is panning through content in a certain direction (e.g., to the right), the view adapter may assume that the user will continue to pan through the content in that direction and therefore may attempt to collect portions of the content further in that direction before the user actual pans that far, based on a prediction that the user will pan further in that direction sometime in the near future. Additionally, the view adapter may store pixels from the underlying content at varying levels of detail, in anticipation of the user zooming in or out on the same location of content. For example, if the user pans to a specific location in a document and then stops panning, the user might zoom in or out at that location so the view adapter might construct images of the document at several different zoom levels in anticipation that the user will actually zoom in or out at that location. The system may store various different views of the content at different zoom levels for some time, and may also flush the stored views when it is anticipated that the stored views are not likely to be used in the near future. By pre-calculating views of the content in anticipation of user commands that have not yet been issued, it is possible to increase the perception of performance by being able to provide views quickly after they are requested. Additionally, by flushing views that the view adapter believes are not likely to be used in the near future, the amount of space used to store the views is reduced.

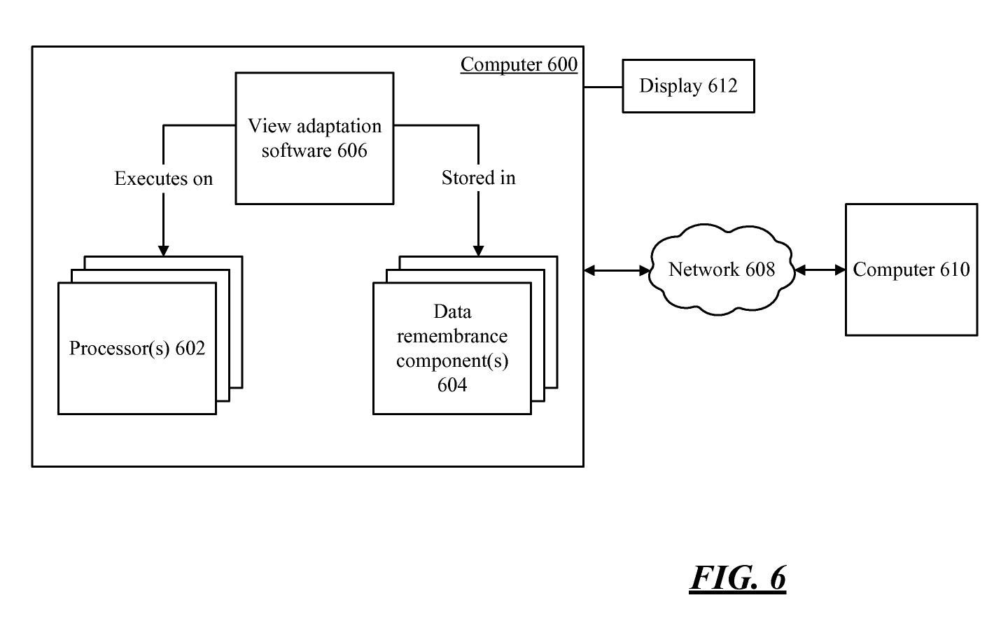

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is view adaptation software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable storage media. (Tangible media, such as an optical disks or magnetic disks, are examples of storage media.) Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through network 608. Computer 610, which may be similar in structure to computer 600, is an example of a device that can be connected to computer 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to provide view functionality to an application, wherein the executable instructions, when executed by a computer, cause the computer to perform acts comprising:
detecting a first location of a first scroll bar in a view box of an application, content being displayed through said view box;
using said first location of said first scroll bar to navigate said content without said navigation being visible to a user of said application, and to collect pixels that represent said content; and
overlaying information based on said pixels on top of said view box.

2. The one or more computer-readable storage media of claim 1, wherein said detecting of said first location comprises using metadata, provided by said application, which specifies said first location of said first scroll bar.

3. The one or more computer-readable storage media of claim 1, wherein said detecting of said first location comprises:
observing that a user of said application has used a pointing device to click on a second location in an interface of said application;
observing that said user has indicated, with said pointing device, a move from said second location to a third location, said second location and said third location being within said first location; and
observing that, following said move, scrolling of content in said view box has occurred.

4. The one or more computer-readable storage media of claim 1, wherein said acts further comprise:
detecting a fourth location at which said view box is located.

5. The one or more computer-readable storage media of claim 1, wherein said view box comprises a second scroll bar, said first scroll bar being a vertical scroll bar, said second scroll bar being a horizontal scroll bar, and wherein said acts further comprise:
using said horizontal scroll bar in said application to navigate said content.

6. The one or more computer-readable storage media of claim 1, wherein said application is run in a computer system that displays, to a user, windows of at least some application instances, wherein said using of said first location of said first scroll bar to navigate said content is not displayed in a window.

7. The one or more computer-readable storage media of claim 1, wherein said overlaying of said information based on said pixels on top of said view box comprises:
putting said pixels in a document;
displaying said document as an overlay on top of said view box.

8. The one or more computer-readable storage media of claim 7, wherein said acts further comprise:
removing said pixels from said document based on a prediction that said pixels are not likely to be requested by a user.

9. The one or more computer-readable storage media of claim 1, wherein said acts further comprise:
intercepting commands that a user issues through a window of said application; and
determining which portions of said content to navigate to, and to collect pixels from, based on said commands.

10. The one or more computer-readable storage media of claim 9, wherein one of said commands indicates a zoom level, and wherein said acts further comprise:
scaling said content based on said zoom level.

11. The one or more computer-readable storage media of claim 1, wherein said acts further comprise:
anticipating, based on portions of said content that have been requested by a user, a portion of said content to be requested by said user in advance of said user's having issued a command to obtain said portion; and
obtaining said portion of said content using said application.

12. The one or more computer-readable storage media of claim 1, wherein said acts further comprise:
anticipating, based on zoom levels of said content that have been requested by said user, a zoom level at which to show said content in advance of said user's having issued a command to view said content at said zoom level; and
scaling said content to said zoom level.

13. A method of obtaining content requested by a user, wherein the method comprises:
using a processor to perform acts comprising:
detecting a first location of a scroll bar of a first view box in an application that a user is using to view content;
using said first location of said scroll bar to navigate through said content said first view box, wherein navigation of said content is not made visible to said user on a display device;
storing pixels that represent said content; and
overlaying said pixels on top of said view box.

14. The method of claim 13, wherein said acts further comprise:
receiving commands from said user through a window of said application; and
using said commands to determine where to navigate in said content in said application.

15. The method of claim 13, wherein said acts further comprise:
anticipating which portions of said content said user is likely to want to view, and a zoom level at which said user is likely to want to view said portions;
navigating to said portions in advance of said user's having issued commands requesting said portions; and
storing pixels that represent said portions at said zoom level.

16. The method of claim 13, wherein said detecting of said first location comprises:
using metadata provided by said application to determine where said scroll bar is located.

17. The method of claim 13, wherein said detecting of said first location comprises:
observing input issued by said user to said application, and actions taken by said application following said input; and
determining, based on said input and said actions, where said scroll bar is located.

18. The method of claim 17, wherein said determining comprises:
observing that said user has used a pointing device to click on a second location in a window of said application;
observing that said user has indicated, with said pointing device, a move from said second location to a third location, said second location and said third location being within said first location; and
observing that, following said move, scrolling of content in said view box has occurred.

19. A system for responding to commands from a user who operates an application, the system comprising:
a processor on which said application executes;
a data remembrance component in which said application is stored;
a view adapter that is stored in said data remembrance component and that executes on said processor, said view adapter intercepting commands issued by said user through a window on which said application executes, said view adapter issuing commands to obtain content through said application, said application being visible to said user on a display, but interactions between said view adapter and said application not being visible to said user on said display; and
a document in which said view adapter stores pixels that represent content that said view adapter obtains through said application, said view adapter causing said document to be overlaid on top of a view box of said application so as to appear in place of said content.

20. The system of claim 19, wherein said view adapter detects a location of said view box and of a scroll bar in said view box either by:
receiving metadata from said application; or
observing motions of a pointing device in said window and actions of said application that follow said motions, and determining that said motions and said actions are consistent with said view box and a scroll bar of said view box being in said location; wherein said view adapter uses said location to navigate said content in said application.
